(19) United States
(12) Patent Application Publication
(10) Pub. No.: US 2007/0027580 A1
(43) Pub. Date: Feb. 1, 2007

(54) Thermal control of an electronic device for adapting to ambient conditions

(76) Inventors: Chris A. Ligtenberg, San Carlos, CA (US); John C. Difonzo, Emerald Hills, CA (US)

Correspondence Address: FISH & RICHARDSON P.C., PO BOX 1022, MINNEAPOLIS, MN, 55440-1022, US

(21) Appl. No.: 11/181,477

(22) Filed: Jul. 14, 2005

(51) Int. Cl. G05D 23/00

(52) U.S. Cl. 700/300

(57) ABSTRACT

Systems and techniques for managing operations of an electronic device involve detecting an environmental condition in a vicinity of an electronic device. In response to the detected environmental condition, a thermal management or user interface operation of the electronic device is altered. The thermal management operation can relate, for example, to an operating parameter of a heat-generating or heat-dissipating component. The user interface operation can relate, for example, to a power savings technique.

### TECHNICAL FIELD

This description relates to operations of electronic devices, and more particularly to providing thermal control of electronic devices for adapting to ambient conditions.

### BACKGROUND

As the design of computers and other electronic devices continue to include more capabilities and become more compact and to use smaller and more powerful integrated circuits and other modules, preventing such electronic devices from overheating, in turn, becomes increasingly difficult. Integrated circuits produce significant amounts of heat when performing processing operations. Other modules and components, such as a video chip or DVD drive, also generate heat when they are active. As the number of features offered in an electronic device increase, the number of potential heat sources also frequently increases. To prevent integrated circuits and other modules and components from burning up, the generated heat needs to be dissipated.

Typically, two mechanisms are available to dissipate heat in an electronic device—fans and product or device enclosures or housings. Fans operate as a heat conduit by circulating air to enable relatively cooler air to absorb thermal energy and to move relatively hotter air in the vicinity of a heat-generating component away from that component. In the context of an electronic device, a fan generally operates to enable heat transfer to an ambient environment. Housings or enclosures for an electronic device can also be used as a heat conduit. Through strategic placement of device components, selection of fabrication materials, and assembly design, heat generated by components of an electronic device can be transferred to an ambient environment through the device enclosure. In some devices, fans and device housings are used in combination for heat dissipation.

In some cases, the use of fans and product enclosures as heat conduits can have some undesirable side effects. Fans produce noise, and, although larger fans typically have a greater cooling capacity, they also generate more noise. The availability of product housings as a heat conduit is limited by safety concerns. If a product housing becomes too hot, it can become a fire hazard or can cause burns if touched. More powerful and smaller devices exacerbate these potential problems because they tend to pack more heat-generating components into smaller packages, which limits the space for fans and the available surface area of the device housing for heat dissipation in addition to placing the heat-generating components in closer proximity to one another. These problems are more pronounced in portable devices, such as laptop computers, which include housings that are frequently in contact with users and for which size constraints (e.g., in terms of thickness or longest exterior dimension) are even more important and inflexible.

### SUMMARY

In one general aspect, thermal properties of an electronic device are managed by detecting an environmental condition in a vicinity of an electronic device and altering a thermal management operation of the electronic device in response to the detected environmental condition.

Implementations can include one or more of the following features. The thermal management operation effects a change in a rate of heat dissipation or changes an operation of a heat-generating component of the electronic device. Detecting an environmental condition includes detecting a change in the environmental condition. A heat dissipation capacity of a set of thermal control resources is estimated, and a thermal control operation corresponding to the estimated heat dissipation capacity is selected. The environmental condition relates to a proximity of a user. Data relating to a progression of detected environmental conditions or a progression of heat-generating operations is stored, and a thermal load on the electronic device is predicted. The thermal management operation is altered in response to the predicted thermal load. A user of a thermal management option is notified, and the thermal management operation is altered in response to a user selection of the thermal management option. The detected environmental condition includes a noise level, and the thermal management operation is altered by adjusting a fan speed based on the noise level. The detected environmental condition includes an ambient temperature, and a rate of heat dissipation is predicted based on the ambient temperature. The thermal management operation is altered in response to the predicted rate of heat dissipation.

In another general aspect, a sensor detects an environmental condition of an electronic device, and a thermal control module selects among multiple thermal control algorithms based on the environmental condition.

Implementations can include one or more of the following features. The electronic device includes a heat-generating component, and the thermal control algorithms provide different operating parameters for the heat-generating component based on the environmental condition. The electronic device includes a heat-dissipating component, and the thermal control algorithms provide different operating parameters for the heat-dissipating component based on the environmental condition. The thermal control module estimates a heat dissipation capacity of a set of heat dissipation resources and selects among the thermal control algorithms based on the estimated heat dissipation capacity. The sensor operates to detect one or more environmental conditions, such as an ambient temperature, an ambient noise level, an ambient humidity, and an ambient air pressure. The sensor is a proximity detector and the environmental condition is a proximity of a user.

In another general aspect, data indicative of a set of ambient environmental conditions for an electronic device is received, and an operating parameter corresponding to the set of environmental conditions is selected from multiple possible operating parameters. Each operating parameter defines a different mode of operation for a set of components of the electronic device.

Implementations can include one or more of the following features. The mode of operation for each operating parameter includes a different thermal management operation. The operating parameter is selected based on a relative heat dissipation capacity of the electronic device for the set of ambient environmental conditions. Each component in the set of components is a heat-generating component or a heat-dissipating component. The operating parameter is selected based on operations of one or more heat-generating components. The data indicative of the set of ambient environmental conditions includes data from a proximity detector, and the mode of operation relates to a user interface feature. The data from the proximity detector indicates a presence of a user, and the mode of operation involves delaying a power savings operation relative to when the data from the proximity detector does not indicate a presence of a user. Alternatively, when the data from the proximity detector does not indicate a presence of a user, the mode of operation involves activating a security feature.

In yet another general aspect, operations of an electronic device are controlled by detecting whether a user is present in a proximity of an electronic device and controlling one or more operations of the electronic device based on the detection of whether a user is present. The operation or operations include activating a security feature, preventing an activation of a power savings operation, and/or activating a power savings operation.

The details of one or more implementations are set forth in the accompanying drawings and the description below. Other features will be apparent from the description and drawings, and from the claims.

### DESCRIPTION OF DRAWINGS

FIG. 1 is a block diagram of a thermal management system.

FIG. 2 is a flow diagram of a process for managing thermal properties of an electronic device.

FIG. 3 is a flow diagram of another thermal management process.

Like reference symbols in the various drawings indicate like elements.

### DETAILED DESCRIPTION

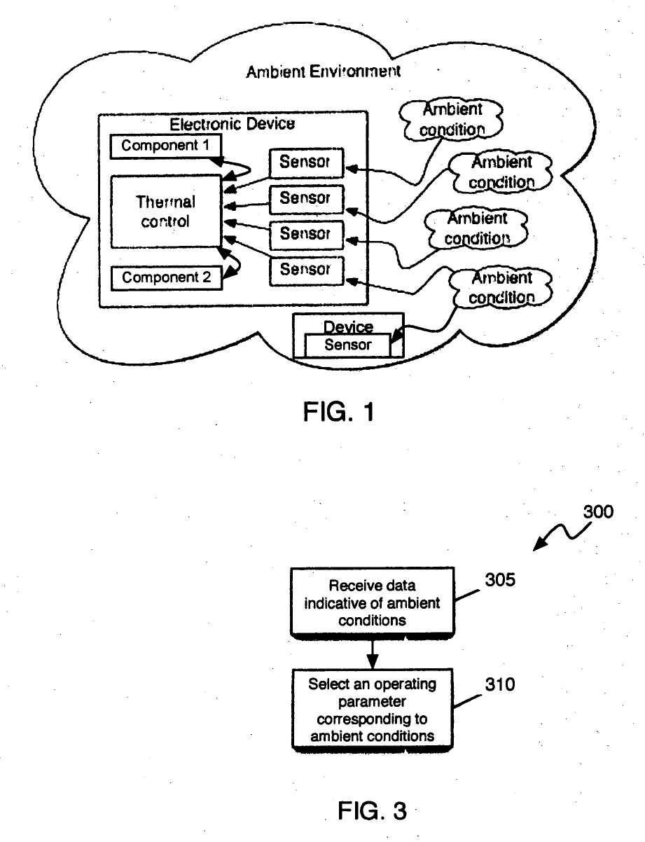

FIG. 1 is a block diagram of a thermal management system 100. The thermal management system 100 is implemented on an electronic device 105 in an ambient environment 110. The electronic device 105 can be, for example, a desktop or laptop computer, a server, a personal digital assistant, a gaming console, or some special-purpose processing device. The electronic device 105 includes one or more sensors 115 each of which is designed to detect one or more corresponding ambient conditions 120. Generally, the ambient conditions 120 include conditions that are present in the external vicinity of the electronic device 105 and not inside the electronic device 105 (e.g., within the device enclosure or housing).

The sensors 115 can be designed to detect ambient conditions 120 in an immediate vicinity of the electronic device 105 (e.g., at one or more external surfaces of the electronic device) or can be designed to detect ambient conditions 120 in a more general vicinity (e.g., within a room where the electronic device 105 is located or within a foot or two of the electronic device 105). To detect ambient conditions 120 in a general vicinity, the sensors 115 can be located such that the electronic device 105 is unlikely to contribute to or interfere with the ambient conditions 120. For example, the sensors 115 can be located on a portion of the electronic device 105 that is relatively remote from any heat- or noise-generating components (e.g., placing a thermometer near a top corner of a display screen on a laptop computer or on a physical extension from the device 105, such as an antenna) or in a device 125 that is separate from the electronic device 105 (e.g., a device 125 that uses a local wireless link, such as Bluetooth, to communicate data regarding ambient conditions to the electronic device 105).

Typically, the sensors 115 do not need to measure ambient conditions 120 at a high frequency. Although high frequency measurements are possible, in some implementations, data can be averaged over longer periods or sensors can be relatively slow to react to changes, which can help avoid changes in operation that are based on relatively short-term environmental changes. The sensors 115 can also have any degree of sensitivity or resolution. For example, in some implementations and/or for some ambient conditions 120, it may be sufficient to only distinguish between relatively large differences in ambient conditions 120, while in other implementations and/or for some ambient conditions 120 it may be desirable to identify small variations in ambient conditions 120.

In some cases, the sensors 115 can be located and designed such that they measure conditions internal to the electronic device 105, which can be processed or otherwise used to be able to reliably predict ambient, external conditions 120. For example, a sensor 115 may be positioned in an internal location that is generally unaffected, or that is affected in a predictable manner, by heat-generating operations or other relevant operations of the electronic device 105. Some electronic devices 105, such as laptop computers, may include certain sensors that are used for other purposes. For example, laptop computers frequently include a built-in microphone and/or internal thermistors for detecting internal overheating conditions. Such sensors can be used, in some cases, for detecting ambient conditions 120. The internal thermistors can be used to detect an ambient temperature at start-up, provided the electronic device 105 has been shut-down for a sufficient period, which temperature can be assumed as the ambient temperature during a usage session. The internal thermistors can also be used to calculate an ambient temperature based on know heat-generating and heat-dissipating characteristics of the electronic device 105 (e.g., if the CPU is operating at a particular speed and operating level and a cooling fan is operating at a particular speed, it may be possible to calculate an approximate ambient temperature or cooling capacity).

Multiple sensors 115 can be used to detect the same ambient condition or conditions 120. Such redundancy can be used to more reliably detect ambient conditions 120 in cases where different parts of the electronic device 105 are subject to different ambient conditions 120 (e.g., the electronic device 105 is in a generally cool environment but is resting on a warm surface), to account for situations where operations of the electronic device 105 contribute to some ambient environmental conditions 120 (e.g., a detector located near a processor may be impacted by heat-generating operations of the processor), and/or to determine the heat dissipation capacities of different heat conduits (e.g., two different locations on the housing of the electronic device 105).

The ambient conditions 120 can include, for example, ambient temperature, ambient noise, ambient air pressure, ambient relative or absolute humidity, and presence or absence of users in a vicinity of the electronic device 105. Accordingly, the sensors 115 can include, for example, thermometers or thermistors, microphones, altimeters or barometers, hygrometers or psychrometers, and proximity detectors.

Ambient temperature, ambient air pressure, and ambient humidity can affect the rate of heat dissipation. For example, a larger temperature differential between an electronic device 105 and an ambient environment 110 enables more rapid cooling than a smaller temperature differential, higher air pressure enables more rapid cooling than lower air pressure, and moist air enables more rapid cooling than dry air. Ambient noise and the presence or absence of users can impact decisions relating to thermal management operations. For example, a noisier environment may justify using a higher fan speed than a quiet environment and an absence of a user may justify increasing reliance on a heat conduit (e.g., a cooling fan and/or a transfer of heat to a device housing) or discontinuing or reducing operations of heat-generating components, such as processors, modules, and other components. Other types of sensors 115 for detecting the conditions 120 listed above or other ambient conditions 120 can also be used.

Data from the sensors 115 relating to ambient conditions 120 is provided to a thermal control module 130. The thermal control module 130 can be a dedicated hardware device (e.g., an ASIC) or a software module that runs on a general-purpose processor. The thermal control module 130 processes the data from the sensors 115 in accordance with one or more control algorithms. Alternatively or in addition, the thermal control module 130 can select among different control algorithms based on the detected ambient conditions 120. The control algorithms can be used to determine when and to what degree to alter (e.g., to initiate, stop, or change) an operation of a heat-dissipating process or component, to determine when and to what degree to alter an operation of a heat-generating process or component, to predict a heat-dissipating capacity and/or rate of heat generation of the electronic device 105, to determine when to provide a user notification, and/or to determine when to alter other operations (e.g., user interface functions) of the electronic device 105. Some control operations are used to alter one or more operating parameters of one or more components 135 of the electronic device 105 based on the detected ambient conditions 120.

In addition, the thermal control module 130 can receive data from one or more components 135 of the electronic device 105. The components 135 can include, for example, components that implement or support features of the electronic device 105 (e.g., heat-generating components), components that relate to heat-dissipation operations, and/or components that detect interior conditions of the electronic device 105. The received data can be used to predict situations that may result in increased or decreased heat generation or to determine when changes in operating parameters need to be made. The data received from the components 135 can be used independently of, or in combination with, the data from the sensors 115. Some control operations are used to alter one or more operating parameters of one or more components 135 of the electronic device 105 based on the state of the same or other components 135.

The data received from the components 135 can be used to determine when and to what degree to alter an operation of a heat-dissipating process or component, to determine when and to what degree to alter an operation of a heat-generating process or component, to predict a heat-dissipating capacity and/or rate of heat generation of the electronic device 105, to determine when to provide a user notification, and/or to determine when to alter other operations (e.g., user interface functions) of the electronic device 105. For example, the data received from the components 135 can relate to a degree of activity of the components 135. If the central processing unit (CPU) is particularly active performing processing tasks, for instance, the thermal management module 130 can predict that the temperature inside the electronic device 105 is likely to increase. The operation of other components 135 can similarly affect the generation or dissipation of heat in the electronic device 105.

In general, the thermal control module 130 can alter operating parameters or otherwise implement changes in an operation of the electronic device 105 based on the ambient conditions 120, absolute or relative changes in the ambient conditions 120, and/or a rate of change in the ambient conditions 120. The thermal control module 130 can also alter operating parameters or otherwise implement changes in an operation of the electronic device 105 based on operations, changes in operations, and/or rates of change in operations of the components 135. Analyzing ambient conditions 120 in conjunction with operations of the components 135 can be used to further enhance thermal management of the electronic device 105. Alterations in the operating parameters can be used to increase a cooling efficiency, increase a power usage efficiency, increase a rate of cooling, build up a cooling buffer (e.g., by cooling the electronic device 105 to a lower than normal level), and/or improve a user experience with the electronic device 105 (e.g., by managing fan noise or heating of the device housing or managing operations based on a presence or absence of a user).

Each sensor 115 generally collects a different type of information on the environment 110 and can allow the electronic device 105 to adapt to the environment 110 in a different way. For example, a microphone can detect a level of ambient noise. Fan noise is not as noticeable in a noisy environment (e.g., an office or an airplane) but is more noticeable in a quiet environment (e.g., a library or at home at night). In response to detecting an ambient noise level, the thermal control module 130 can adjust a parameter relating to a maximum fan speed by increasing the maximum fan speed in a noisy environment and decreasing the maximum fan speed in a quiet environment. For example, while a computer might normally limit a fan size and speed to preclude noise greater than 40 dB, which might be a noise level of a typical home at night, such a limit may be unnecessarily low in some environments. A typical office environment may be at 60-65 dB and an airline during flight may be at 90 dB. Such noise levels present an opportunity for increased fan noise levels without noticeably detracting from a user experience. Adjustments to the maximum fan speed do not necessarily affect the actual fan speed, which may be controlled based on other factors (e.g., internal temperatures of the device, operating conditions, etc.). Accordingly, the fan speed does not need to be actually increased up to a maximum fan speed unless it is otherwise determined that additional cooling is necessary.

In some implementations, the thermal control module 130 can process data relating to ambient noise levels to account for noise generated by the electronic device 105 itself. For example, the noise created by typing on the keys of the keyboard or by the internal cooling fan can be disregarded to more accurately determine the actual ambient noise level. On the other hand, other contributions by the electronic device 105, such as sounds from the speakers, may be considered to be part of the actual ambient noise level or may be considered at a different weighting than other external noises. For example, sounds from the speakers may not be given a full weighting to prevent situations where fan noise might interfere with high fidelity sound (e.g., music or video sound effects). The effects of the electronic device 105 can also be considered in determining other ambient conditions 120. In many implementations, however, it may be unnecessary to consider the effects of the electronic device 105 and is operations on ambient conditions 120.

The ambient conditions 120 detected by the sensors 115 can also be used in combination to adjust operating parameters. For example, the ambient noise can be used with the ambient temperature to determine when to increase the fan speed to promote faster cooling (e.g., to enable high fan speeds only in environments 110 that are both especially warm and relatively noisy). In addition, the ambient temperature, air pressure, and/or humidity information can be used to estimate a cooling/heat-dissipating capacity of the electronic device 105. The cooling capacity of the electronic device 105 can also be used to gather data regarding heat-generating characteristics of different operations, which, in turn, can be used in the future to more accurately predict the thermal performance of the electronic device 105. For example, if the thermal control module 130 is able to collect sufficient information about the cooling capacity and heat-generating capacity in various environmental conditions and under various operating conditions, the thermal control module 130 may be able to better predict and adjust for potential thermal management problems before they become critical.

Furthermore, the thermal control module 130 can use an estimate of a heat-dissipating capacity of the electronic device 105 to manage operations of other components 135 to more effectively constrain heat-generating operations and/or to improve user satisfaction. For example, the thermal control module 130 can manage CPU speed or a battery-charging rate in accordance with the heat-dissipating capacity. In a hot, dry, and/or low air pressure environment, the thermal control module 130 can increase fan speed sooner in response to increased power use, can lower CPU speed at a lower internal temperature threshold than normal, and/or can decrease the battery charging rate to reduce heat generation. In a cool, wet, and/or high air pressure environment, the thermal control module 130 can lower a maximum fan speed parameter, delay increases in fan speed, and/or allow faster battery charging rates. Under some conditions 120, the electronic device 105 may deduce information from the data collected by the sensors 115. For example, in a low humidity, high altitude, and high noise environment, the thermal control module 130 may enter into an “airplane mode” (airlines use relatively dry air with an air pressure that is equivalent to about eight thousand feet altitude), in which it runs a fan at a high speed to keep the unit very cool and/or to reduce reliance on the device housing as a heat conduit because the electronic device 105 is likely to be used on a person's lap.

A proximity detector can be used to determine when a user is away from the electronic device 105. In response, the thermal control module 130 can change operating parameters, which may have been set at a level that did not provide maximum cooling in order to improve the user experience (e.g., to reduce fan noise). For example, the thermal control module 130 can increase the fan speed to a level that would cause too much noise if a user were nearby, which may enable a corresponding increase in CPU speed, and/or shut down human interface features, such as an LCD screen or a high bandwidth network connection. Any type of proximity detection technique can be used, such as infrared, optical, or ultrasonic techniques. In general, proximity detection will not necessarily be limited to detecting an actual user of the electronic device 105 because the proximity detector will also detect the presence of others in a vicinity of the electronic device 105. For purposes of this description, a user, in the context of proximity detection, can also include others who are not necessarily a user of a device at issue.

In addition to thermal management uses, a proximity detector can also be used for improving a user's experience or satisfaction, activating security features, and/or improving power savings. For example, the proximity detector can be used to determine when to shut down or not to shut down user interface features or other components 135. Many conventional computer displays enter a powered-down state after a particular period of inactivity (e.g., a period in which no interaction with a mouse or keyboard occurs). This power-down operation can help conserve power, among other things. By basing the power-down operation on a proximity detector, however, it may be possible to initiate the power-down operation sooner when the user is away to increase power savings and to prevent potentially annoying and unwanted power-downs when the user is present but is simply reading information on the screen. The absence of the user can also be detected sooner to enable the electronic device to activate a security feature, such as placing the electronic device 105 in a locked state that requires a user password to unlock.

The thermal control module 130 can implement algorithms for predicting a likelihood and/or a rate of heat build-up in the electronic device 105, predicting usage patterns and demands on heat-generating and heat-dissipating components 135, and predicting rates of heat-dissipation. The predicted information can be used to perform certain thermal management operations. For example, an increase in processor usage coupled with a high ambient temperature can be used to predict that a maximum internal operating temperature for the electronic device 105 may be reached in a particular number of minutes. In addition, the thermal control module 130 can also implement algorithms for determining how a rate of heat-dissipation will change for an electronic device 105 as the internal temperature increase based on particular ambient and operating conditions. As another example, if the thermal control module 130 detects a pattern of processor-intensive operations, the thermal control module 130 may predict that additional such operations are likely to occur and implement an algorithm for significantly increasing cooling when a user steps away from the electronic device 105. In some implementations, such algorithms may provide for cooling to a level well below normal operating conditions in anticipation of additional heat-generating operations. Predictions can be based on known heat-generating and heat-dissipating characteristics of the electronic device 105 and/or its components 135.

Other sophisticated prediction or control algorithms can also be used. For example, control of heat-generating and heat-dissipating components can be based on a location of the components 135 within the electronic device 105 and/or locations of sensors 115 for detecting ambient conditions 120. Accordingly, multiple sensors 115 may be included on an electronic device 105 at different locations. Which sensor or sensors 115 are used for a particular control algorithm can vary depending, for example, upon the operations controlled by the algorithm and/or the operations of the components 135. As one example, different operations may involve different heat-generating components, which cause heat to be generated at different locations on or within the electronic device 105. Image processing, such as a Gaussian blur, playing video games, and reading a DVD can cause different parts (in this example, the CPU, a video chip, and a DVD drive, respectively) of the electronic device 105 to heat up more rapidly. Based on this knowledge, a sensor 115 that is most remote from the currently active components 135 may be used to determine ambient conditions 120.

Alternatively or in addition, control of heat-dissipating operations may differ depending on the location of the currently active heat-generating components. For example, components 135 that are likely to cause more rapid heating of user contact surfaces can result in a more rapid heat-dissipation strategy than is otherwise used. Moreover, because a higher thermal conductivity of a material causes a greater sensation of heat (e.g., aluminum feels hotter than titanium at the same temperature), the heat-dissipating operations can also be based on the construction material of the device housing at the user contact surfaces. Prediction or control algorithms can also use other information, such as the type of application being executed on the CPU, the rate of video processing necessary for a particular video game, and the type of DVD being read (e.g., a DVD containing still photographs may be handled differently than a full length movie).

In some implementations, the detected ambient conditions and/or the status of heat-generating operations can result in a warning or option being presented on a user interface. For example, in a hot ambient environment, a message can be displayed on a user interface to inform the user that moving to a cooler location will result in better performance (e.g., by preventing the need to slow down CPU speed). A user selection option can also be presented, giving a user the option between selecting a higher (and thus noisier) fan speed or a slower CPU speed.

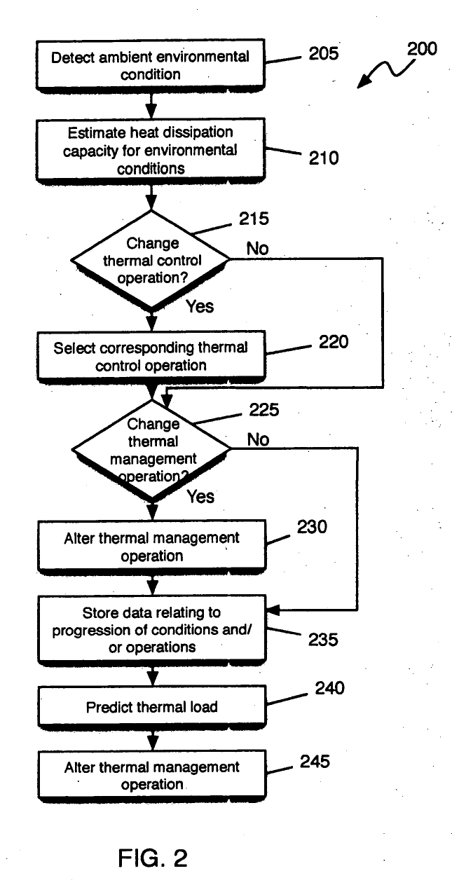

FIG. 2 is a flow diagram of a process 200 for managing thermal properties of an electronic device. Typically, the process 200 is performed continuously to allow for continuous adjustments, although the process 200 can also be initiated periodically (e.g., at time intervals) or iteratively (e.g., in a looped manner). A condition is detected in an ambient environment of the electronic device (205). Generally, the detected condition relates to a condition in an external vicinity of the electronic device, although in some cases conditions internal to the electronic device can be used to estimate external, ambient conditions. The vicinity in which ambient conditions are detected is generally selected such that the conditions are expected to be roughly equivalent to the conditions adjacent to one or more surfaces of the electronic device. In some cases, multiple ambient environmental conditions can be detected. The detected ambient condition or conditions can include a temperature, a noise level, an air pressure, a humidity level, and/or a proximity state of a user.

A heat dissipation capacity of a set of thermal control resources for the detected ambient environment is estimated (210). The set of thermal control resources can be one or more components, such as cooling fans and portions of a device housing designed to function as a heat conduit, that operate or are capable of operating to dissipate heat generated by the electronic device. The heat dissipation capacity relates to the ability of the set of thermal control resources to cool the electronic device and can be measured, for example, in terms of an amount of heat that can be dissipated per unit of time (i.e., a rate of heat dissipation), a heat dissipation function that changes depending on the temperature of the electronic device, and/or an amount of time before the electronic device will reach a maximum temperature or will have to change an operation of one or more heat-generating components. The heat dissipation capacity can be based, for example, on a maximum level of heat dissipation, one or more available levels of heat dissipation (e.g., based on an operating level on one or more thermal control resources), or a current heat dissipation capacity, which can differ depending on, for example, whether a cooling fan speed is currently operating at a maximum level. The heat dissipation capacity can be estimated based, in part or solely, on one or more ambient conditions. For example, the heat dissipation capacity will generally be greater in a cooler ambient environment. Thus, the heat dissipation capacity can be based on the ambient temperature alone or on the ambient temperature in conjunction with other considerations (e.g., ambient air pressure, ambient humidity, or parameters associated with a component of the device).

Based on the estimated heat dissipation capacity for the current ambient environment, it is determined whether a change is needed in a current thermal control operation (215). In general, an electronic device operates in accordance with a thermal control operation or algorithm that is used to determine when to change one or more operating parameters that relate to the thermal characteristics of the device. For example, the thermal control operation can be used to determine when to reduce loads (e.g., slowing a processor speed) so that the device generates less heat and/or when to activate or increase an active cooling feature (e.g., increasing fan speed) so that the device dissipates heat at a faster rate.

If it is determined that a change is needed in the current thermal control algorithm, the estimated heat dissipation capacity for the current ambient environment is used to select an appropriate new thermal control operation that corresponds to the current ambient environment (220). The thermal control operation can be an algorithm that controls when changes are made to different heat-generating and/or heat-dissipating operations. For example, in a hot environment, a thermal control operation is selected that causes heat-dissipating operations to increase, or that causes heat-generating operations to decrease, at a lower internal device temperature than normal. In a cool environment, a different thermal control operation is selected that sets operating parameters at a level that provides for increased user satisfaction (e.g., by setting lower noise standards and maximizing processing speed). The thermal control algorithm selected can also depend on whether a user is detected in the vicinity of the device. Multiple different thermal control operations can be defined, and each one can correspond to a unique set and/or range of operating and ambient environmental conditions.

It is determined whether a change is needed in a thermal management operation (225). For example, the thermal control operation (selected at 220 or previously in effect) can be an algorithm that determines whether a change is needed in a thermal management operation of the electronic device. The decision can be based, for example, on one or more of the detected environmental conditions, one or more detected internal temperatures, and/or an active/inactive state of one or more components of the device.

If it is determined that a change is needed (at 225), a thermal management operation of the electronic device is altered (230). The alteration of the thermal management operation can also be based on the estimated heat dissipation capacity and/or on an estimated rate of heat generation, which can be estimated according to a current usage level of a heat-generating component (e.g., on, off, or half speed) or a usage pattern (e.g., repeats of on for ten seconds and off for five seconds). The thermal management operation that is altered can effect a change in a rate of heat dissipation for the electronic device. For example, the thermal management operation can involve increasing a fan speed to increase a rate of cooling and/or changing a rate of heat transfer to a device housing (e.g., using adjustable louvers). Alternatively or in addition, the thermal management operation that is altered can involve changing an operation of a heat-generating component of the electronic device, such as changing a rate of battery charging, adjusting a CPU speed, switching off or reducing multitasking operations, and the like.

The thermal management operation can be altered in response to a particular level or levels of one or more ambient conditions or in response to a change (e.g., absolute differential or rate of change) in one or more detected ambient conditions. The alteration of the thermal management operation can be based on a relatively complex interaction among one or more ambient conditions and/or one or more hardware or software operations performed by the electronic device. In some implementations, a notification relating to one or more ambient conditions (e.g., a thermal management option) can be presented to a user, and the thermal management operation can be altered in response to a user selection of an operating parameter (e.g., a selection of the thermal management option).

Data relating to a progression or periodic sequence of detected environmental conditions and/or a pattern or progression of heat-generating operations is stored (235). In other words, historical data relating to ambient conditions and/or operations of device components is stored. The historical data is used to predict a current or future thermal load on the electronic device (240), and a thermal management operation is altered in response to the predicted thermal load (245). The thermal load can include a rate of heat generation, a rate of heat dissipation, and/or a net rate of heat transfer.

FIG. 3 is a flow diagram of another thermal management process 300. Data indicative of a set of ambient environmental conditions for an electronic device is received (305). The data can be in the form of raw measurement data, data that is converted to a particular measurement system, or quantized data (i.e., an indication of a range of measurements that the ambient condition falls within). The set of ambient conditions can include one or more ambient conditions, such as temperature, air pressure, and noise level.

An operating parameter is selected based on the set of ambient environmental conditions (310). The operating parameter is selected from multiple different operating parameters, each of which corresponds to a different set of ambient conditions. For example, a first operating parameter can correspond to a high temperature, low noise environment, while a second operating parameter corresponds to a high temperature, high noise environment. The operating parameter can be selected based on a relative (e.g., high, medium, or low) heat dissipation capacity of the electronic device for the set of ambient conditions. In addition or in the alternative, the operating parameter can be selected based on predicted and/or detected operations of one or more heat-generating components. In addition, each operating parameter defines a different mode of operation for a set of one or more components of the electronic device. For example, the first operating parameter can define a low fan speed-low CPU speed mode of operation, and the second operating parameter can define a high fan speed-moderate CPU speed mode of operation. The different modes of operation can be different thermal management operations (e.g., for heat-generating and/or heat-dissipating components).

In some implementations, the data indicative of the set of ambient conditions can include data from a proximity detector that indicates a presence or absence of a user, and the mode of operation defined by the selected operating parameter relates to a user interface feature. For example, the selected operating parameter can shut down a user interface feature in response to an absence of the user or can delay a power savings operation (e.g., shutting down a display screen) when the power savings operation would otherwise be initiated after a predetermined amount of time of inactivity or when a user presence is not detected. The delay can be a particular amount of time after the most recent activity or can be until the user presence is no longer detected. As another example, the selected operating parameter can result in an activation of a security feature when the proximity detector does not indicate the presence of a user.

Various implementations of the systems and techniques described here can be realized in digital electronic circuitry, integrated circuitry, specially designed ASICs (application specific integrated circuits), computer hardware, firmware, software, and/or combinations thereof. For example, the thermal control module 130 and other modules, components, and algorithms described above can be implemented in software. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

Although only a few embodiments have been described in detail above, other modifications are possible. Portions of this disclosure discuss techniques for thermal management of laptop computers, but the described techniques are generally applicable to controlling various operations of any type of electronic device. The logic flows depicted in FIGS. 2 and 3 do not require the particular order shown, or sequential order, to achieve desirable results. For example, storage of data relating to a progression of detected environmental conditions or a pattern of heat-generating operations (225) and use of such stored data to predict a thermal load on the electronic device (230) may be performed at many different places within the overall process. In certain implementations, multitasking and parallel processing may be preferable.

Other embodiments may be within the scope of the following claims.

What is claimed is:

1. A method for managing thermal properties of an electronic device, the method comprising:
detecting an environmental condition in a vicinity of an electronic device; and
altering a thermal management operation of the electronic device in response to the detected environmental condition.

2. The method of claim 1 wherein altering the thermal management operation effects a change in a rate of heat dissipation.

3. The method of claim 1 wherein altering the thermal management operation comprises changing an operation of a heat-generating component of the electronic device.

4. The method of claim 1 wherein detecting an environmental condition comprises detecting a change in the environmental condition.

5. The method of claim 1 further comprising:
estimating a heat dissipation capacity of a set of thermal control resources; and
selecting a thermal control operation corresponding to the estimated heat dissipation capacity.

6. The method of claim 1 wherein detecting an environmental condition comprises detecting a proximity of a user.

7. The method of claim 1 further comprising:
storing data relating to at least one of a progression of detected environmental conditions or a progression of heat-generating operations; and
predicting a thermal load on the electronic device, wherein altering the thermal management operation is further performed in response to the predicted thermal load.

8. The method of claim 1 further comprising notifying a user of a thermal management option, wherein altering the thermal management operation is performed in response to a user selection of the thermal management option.

9. The method of claim 1 wherein the detected environmental condition comprises a noise level and altering the thermal management operation comprises adjusting a fan speed based on the noise level.

10. The method of claim 1 wherein the detected environmental condition comprises an ambient temperature, the method further comprising predicting a rate of heat dissipation based at least in part on the ambient temperature, wherein altering the thermal management operation in response to the detected environmental condition comprises altering the thermal management operation at least in part in response to the predicted rate of heat dissipation.

11. An article comprising a machine-readable medium storing instructions for causing data processing apparatus to:
receive data indicative of a set of ambient environmental conditions for an electronic device; and
select an operating parameter corresponding to the set of environmental conditions from a plurality of operating parameters, each operating parameter defining a different mode of operation for a set of components of the electronic device.

12. The article of claim 11 wherein the different mode of operation for each operating parameter comprises a different thermal management operation.

13. The article of claim 12 wherein the operating parameter is selected based on a relative heat dissipation capacity of the electronic device for the set of ambient environmental conditions.

14. The article of claim 13 wherein each component in the set of components is selected from the group consisting of a heat-generating component and a heat-dissipating component.

15. The article of claim 14 wherein the operating parameter is further selected based on operations of at least one heat-generating component.

16. The article of claim 11 wherein the data indicative of the set of ambient environmental conditions comprises data from a proximity detector and the different mode of operation relates to a user interface feature.

17. The article of claim 16 wherein the data from the proximity detector indicates a presence of a user and the different mode of operation comprises delaying a power savings operation relative to when the data from the proximity detector does not indicate a presence of a user.

18. The article of claim 16 wherein the data from the proximity detector does not indicate a presence of a user and the different mode of operation comprises activating a security feature.

19. A thermal management system comprising:
a sensor for detecting an environmental condition of an electronic device; and
a thermal control module operable to select among a plurality of thermal control algorithms based on the environmental condition.

20. The thermal management system of claim 19 wherein the electronic device includes a heat-generating component and the thermal control algorithms provide different operating parameters for the heat-generating component based on the environmental condition.

21. The thermal management system of claim 19 wherein the electronic device includes a heat-dissipating component and the thermal control algorithms provide different operating parameters for the heat-dissipating component based on the environmental condition.

22. The thermal management system of claim 19 wherein the thermal control module is further operable to estimate a heat dissipation capacity of a set of heat dissipation resources and to select among the plurality of thermal control algorithms based on the estimated heat dissipation capacity.

23. A system for controlling operations of an electronic device, the system comprising:
means for detecting an environmental condition of an electronic device; and
means for controlling thermal properties of the electronic device based on the environmental condition.

24. The system of claim 23 wherein the electronic device includes at least one of a means for generating heat or a means for dissipating heat and the means for controlling thermal properties provide different operating parameters for at least one of the means for generating heat or the means for dissipating heat based on the environmental condition.

25. The system of claim 23 wherein:
the means for detecting an environmental condition comprises means for detecting whether a user is present in a proximity of the electronic device; and
the means for controlling thermal properties comprises a means for controlling at least one operation of the electronic device based on the detection of whether a user is present, the at least one operation selected from the group consisting of activating a security feature, preventing an activation of a power savings operation, and activating a power savings operation.
